(19) United States
(12) Patent Application Publication
(10) Pub. No.: US 2014/0268012 A1
(43) Pub. Date: Sep. 18, 2014

(54) IMMERSIVE ENVIRONMENT SYSTEM HAVING MARKED CONTACT LENSES COORDINATED WITH VIEWING STATIONS

(71) Applicant: CHRISTIE DIGITAL SYSTEMS CANADA INC., Kitchener (CA)

(72) Inventors: Douglas Lyle BEAMER, Kitchener (CA); Michael Brent PECKOVER, Kitchener (CA); Zoran VESELIC, Waterloo (CA)

(73) Assignee: CHRISTIE DIGITAL SYSTEMS CANADA INC., Kitchener (CA)

(21) Appl. No.: 13/795,190

(22) Filed: Mar. 12, 2013

(51) Int. Cl. G02C 11/00

(52) U.S. Cl. CPC G02C 11/10
USPC 351/158

(57) ABSTRACT

An immersive environment system having marked contact lenses coordinated with images is provided. The system comprises: a display system configured to display multiplexed images comprising at least a first set of images and a second set of images optically-separable from the first set; a first pair of contact lenses marked as associated with the first set of images and configured to demultiplex the first set from the second set; and, a second pair of contact lenses marked as associated with the second set of images and configured to demultiplex the second set from the first set.

### FIELD

The specification relates generally to immersive environment systems, and specifically to an immersive environment system having contact lenses coordinated with images.

### BACKGROUND

Multi-person immersive environments, such as flight simulators, generally provide the same images for all viewers within the environment. When the images are adjusted for positions of the viewers within the environment, each viewer usually wears special glasses, for example polarized glasses, such that only images intended for a given viewer are viewed. Such glasses restrict viewability, however, and further interfere with headsets, goggles, heads up displays, and the like to be worn in the immersive environment, as well as non-display elements of the immersive environment, such as scopes and the like, for example as part of a flight simulator.

### SUMMARY

In this specification, elements may be described as “configured to” perform one or more functions or “configured for” such functions. In general, an element that is configured to perform or configured for performing a function is configured to perform the function, or is enabled to perform the function, or is suitable for performing the function, or is adapted to perform the function, or is operable to perform the function, or is otherwise capable of performing the function.

The present specification provides a system comprising: a display system configured to display multiplexed images comprising at least a first set of images and a second set of images optically-separable from the first set; a first pair of contact lenses marked as associated with the first set of images and configured to demultiplex the first set from the second set; and, a second pair of contact lenses marked as associated with the second set of images and configured to demultiplex the second set from the first set.

The first set and the second set can be optically separable via one or more of different respective colour schemes and different respective polarization schemes.

Each of the first pair of contact lenses and the second pair of contact lenses can comprise one or more of different respective colour schemes and different respective polarization schemes for respectively demultiplexing the first set from the second set and the second set from the first set.

Each of the first pair of contact lenses and the second pair of contact lenses can be marked as associated with a respective set of images using one or more of text, graphics, RFID (radio frequency identification) tags and NFC (near field communication) tags.

The system can further comprise a first container for the first pair of contact lenses and a second container for the second pair of contact lenses, wherein each of the first pair of contact lenses and the second pair of contact lenses can be marked as associated with respective images using respective marking on each of the first container and the second container. Each of the first container and the second container can comprise one or more of a contact lens case, an envelope, contact lens packaging, a box, and a holder.

The system can further comprise a first viewing position for viewing the display system using the first pair of contact lenses and a second viewing position for viewing the display system using the second pair of contact lenses, wherein each of the first pair of contact lenses and the second pair of contact lenses can be marked as associated with respective images using marks associated with respective viewing positions. Each of the first viewing position and the second viewing position can be mobile. Each of the first viewing position and the second viewing position can comprise one or more of a viewing station seat, controls for controlling the multiplexed images in an immersive environment and receivers for receiving immersive environment data.

The system can further comprise a first contact lens station and a second contact lens station, each configured for one or more of issuing a respective pair of contact lenses and inserting the respective pair of contact lenses into eyes of a viewer, wherein each of the first contact lens station and the second contact lens station can be marked as associated with respective images using marks associated with respective contact lens stations.

Each of the first set of images and the second set of images can comprise respective stereoscopic images, and each of the first set of contact lenses and the second set of contact lenses can be configured to demultiplex the respective stereoscopic images.

Each contact lens in the first set of contact lenses and the second set of contact lenses can be further marked as associated with one of a right eye and a left eye.

Each of the first set of images and the second set of images can comprise respective monoscopic images, and each of the first set of contact lenses and the second set of contact lenses can be configured to demultiplex the respective monoscopic images.

Each of the first set of images and the second set of images can comprise a similar scene. Each of the first set of images and the second set of images can comprise a different scene.

The display system can comprise one or more of a projector display system, a flat panel display system, a tiled display system, a cathode ray display system, an LCD (liquid crystal display) system, and a OLED (organic light emitting diode) display system. The display system can comprise a projector and a screen upon which the projector projects the first set and the second set. The display system can be configured to generate the multiplexed images one or more of concurrently and alternately.

The system can further comprise a computing device configured to generate the multiplexed images for display by the display system.

The system can further comprise an immersive environment.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts an immersive environment system having marked contact lenses, according to non-limiting implementations.

FIG. 2 depicts the immersive environment system of FIG. 1, with contact lenses located at respective viewing stations, according to non-limiting implementations.

FIG. 3 depicts a stereoscopic immersive environment system having marked contact lenses, according to non-limiting implementations.

FIG. 4 depicts an alternative immersive environment system having marked contact lenses, according to non-limiting implementations.

### DETAILED DESCRIPTION

FIG. 1 depicts an immersive environment system 100, according to non-limiting implementations. System 100 comprises a screen 101 and viewing stations 103-1, 103-2 for viewing screen 101 from points of view respective to each of the viewing stations 103-1, 103-2. Viewing stations 103-1, 103-2 will also be interchangeably referred to hereafter, collectively, as viewing stations 103 and generically as a viewing station 103. Further, while two viewing stations 103 are depicted in FIG. 1, in further implementations system 100 can comprise more than two viewing stations 103. System 100 further comprises at least one projector 105-1, 105-2 configured to project optically-separable (e.g. multiplexed) images 106-1, 106-2, 106-3 . . . 106-n (which are optionally aligned) on screen 101 in at least a one-to-one relationship with viewing stations 103-1. Projectors 105-1, 105-2 will also be interchangeably referred to hereafter, collectively, as projectors 105 and generically as a projector 105.

Optically-separable images 106-1, 106-2, 106-3 . . . 106-n will also be interchangeably referred to hereafter, collectively, as images 106 and generically as an image 106. Further, each of images 106 can comprise a portion of a same scene but adjusted for viewing from a respective point of view of each of viewing stations 103, as described in further detail below. Further, each individual image 106 can be projected on a portion of a reflective surface of screen 101 (the coverage of each projector 105 of screen 101 being represented by stippled lines) or each individual image can be projected on about the entire reflective surface of screen 101; either way, collectively images 106 can be projected on about the entire reflective surface of screen 101 such that viewers viewing screen 101 from each viewing station 103 view images 106 on about the entire reflective surface of screen 101. In other words, each image 106 can cover a portion of screen 101, but collectively images 106 cover about the entire reflective surface of screen 101. As such projectors 105 can be configured for blending images 106 such that the scene projected onto screen 101 is generally seamless. However, in some implementations, not all viewers to see the entire surface of screen 101, and hence in these implementations, not all viewers' content appears on the entire surface of screen 101; for example, in a simulation where a viewer is looking out of a small simulated window has a restricted view and hence only images in the restricted view can be provided.

Furthermore, images 106 need not be always blended. For example, in when screen 101 is faceted, an image on each facet need not be blended into an image on an adjacent facet.

While each of projectors 105 are depicted as projecting images 106 onto screen 101 in a front projection configuration, present implementations are not so limiting and one or more of projectors 105 can be configured for one or more of rear projection onto screen 101 and front projection onto screen 101.

Further, as depicted, system 100 comprises two projectors 105 configured to project the optically-separable images on screen 101. However, in other implementations system 100 can comprise as few as one projector 105 or more than two projectors: e.g. a plurality of projectors 105 for projecting images 106 onto about the entire reflective surface of screen 101.

Further projectors 105 can be configured to project images 106 on screen by one or more of projecting images 106 concurrently and alternately. For example, a projector could be driven at about 120 Hz (e.g, 120 images 106 projected per second), but split into two channels: a first channel for projecting images 106 for viewing station 103-1 and a second channel for projecting images 106 for viewing station 103-2. However, projectors 105 can be driven at other frequencies, including, but not limited to, about 240 Hz and/or any suitable frequency. Further, projectors 105 could be stacked for projecting images 106 for more than two viewing stations. However, the configuration of projectors 105 is generally appreciated to be non-limiting.

As depicted, screen 101, viewing stations 103 and projectors 105 are configured for immersive 270° viewing of screen 101. Indeed, while screen 101 is depicted in partial cross-section, at least partially surrounding viewing stations 103 on lateral sides, it is appreciated that screen 101 can extend above and/or over and/or below and/or under viewing stations 103. However, the configuration of screen 101 is generally appreciated to be non-limiting, and can include, but is not limited to one or more of a flat screen, a faceted screen, a cylindrical screen, a spherical screen and the like.

Further, each of viewing stations 103 can comprise a optional seat for a respective viewer, which, in some implementations, can slide from a viewer loading position into a viewing position, such that a viewer can sit in a seat of a respective viewing station 103, for example, outside of an area defined by screen 101 and/or a viewing area of screen 101, and slide the seat into the viewing position such that screen 101 can be viewed from a given point of view. Further, while a moveable and/or sliding seat is described, in other implementations the seat can be in a fixed position.

System 100 further comprises a plurality of pairs of contact lenses 107-1, 107-2 in a one-to-one relationship with viewing stations 103. Pairs of contact lenses 107-1, 107-2 will also be interchangeably referred to hereafter, collectively, as pairs of contact lenses 107 and generically as a pair of contact lenses 107. Each of the plurality of pairs of contact lenses 107 are marked as associated with a respective viewing station 103. For example, as depicted, each pair of contact lenses 107 is stored in a respective container 108-1, 108-2 (referred to interchangeably hereafter, collectively as containers 108 and generically as a container 108): container 108-1 is marked with a mark “1” corresponding to viewing station 103-1; and, container 108-2 is marked with a mark “2” corresponding to viewing station 103-2. Further, as depicted, viewing station 103-1 is also marked with a mark “1” and viewing station 103-2 is also marked with a mark “2”. Hence, it is apparent that pair of contact lens 107-1 is associated with viewing station 103-1 and pair of contact lenses 107-2 is associated with viewing station 103-2.

In other words, in depicted implementations, system 100 further comprises respective containers 108 for each of the plurality of pairs of contact lenses 107, each of the plurality of pairs of contact lenses 107 marked as associated with a respective viewing station 103 by a respective mark on the respective containers 108. Respective containers can comprise one or more of a contact lens case, an envelope, contact lens packaging, a box, and a holder.

However, marking of pairs of contact lenses 107 as being associated with a respective viewing station 103 can be performed in any suitable manner. Indeed, each contact lens in a pair of contact lenses 107 can be marked, rather than a container.

Furthermore, any mark is within the scope of present implementations. For example, rather than use numbers such as “1”, “2” etc., natural names and the like can be used for marking, including, but not limited to “Pilot”, “Co-Pilot”, “Navigator” and the like. Further, each viewing station 103 need not be marked with a mark similar to a corresponding pair of contact lenses 107. Rather viewing stations 103 can be identifiable as being associated with a given marked pair of contact lenses 107 via configurations of viewing stations 103; for example, a viewing station 103 for a “Pilot” can be identifiable from pilot controls located at the “Pilot” viewing station 103; similarly, a viewing station 103 for a “Co-Pilot” can be identifiable from co-pilot controls located at the “Co-Pilot” viewing station 103; and, a viewing station 103 for a “Navigator” can be identifiable from navigator controls located at the “Navigator” viewing station 103.

Further any suitable words, numbers, letters, graphics etc. can be used to mark a pair of contact lenses 107 as being associated with a given viewing station 103. In yet further implementations wireless marking techniques can be used to mark a pair of contact lenses 107, including, but not limited to RFID (radio frequency identification tags) and NFC (near field communication) tags; in these implementations, system 100 can further include a wireless tag reader, including but not limited to an RFID reader and an NFC reader.

Further, each pair of contact lenses 107 is configured to separate and/or demultiplex at least one respective image 106, associated with a given respective viewing station 103 for which a given pair of contact lenses is marked, from images 106, the at least one respective image 106 adjusted for viewing from a point of view of the given respective viewing station 103, as described below in more detail with reference to FIG. 2.

Further, each pair of contact lenses 107 can be associated with a specific viewer. In other words, a pair of contact lenses 107 can be configured for the vision requirements of a specific viewer, including, but not limited to, a correcting the vision of a specific viewer (e.g. prescription contact lenses). Alternatively, each pair of contact lenses 107 can be non-corrective and be configured for image filtering but not for correcting vision. In yet a further alternative, each pair of contact lenses 107, while non-corrective, could be tailored for a comfortable fit for a viewer: for example pairs of contact lenses 107 and/or each contact lens in each pair of contact lenses 107 could be provided in one or more of a small, medium and large size.

It is further assumed in system 100 that pairs of contact lenses 107 have been provisioned for storage in a given container 108 and/or previously marked as being associated with a given viewing station 103. Such provisioning can occur by matching image filtering capabilities of a pair of contact lenses 107, as described below with reference to FIG. 2, with an optical scheme of images 106 associated with a respective viewing station 103.

System 100 further comprises a computing device 115 in communication with the at least one projector 105, via a suitable respective wired and/or wireless links. Computing device 115 is configured to generate images data for projection by the at least one projector 105 as images 106. For example, computing device 115 can comprise an image generator, and the like, for generating image data for producing images 106. Computing device 115 can, in turn, comprise a processor 120 interconnected with a memory 122 and a communication interface 124. Processor 120 is generally configured to generate image data for projection as images 106 by projectors 105 and communicate the image data to projectors via communication interface 124. Further data for generating the image data can be stored in memory 122.

Computing device 115 is further configured for communication with one or more optional controls 130 via a suitable respective wired and/or wireless link, controls 130 for controlling images 106 in an immersive environment, computing device 115 and/or projectors 105 further configured to change images 106 in response to receiving data from controls 130. For example, controls 130 can comprise a joystick which is used to control images 106 to give the impression of flying an aircraft and the like: when the joystick is actuated, images 106 are updated to give the impression of a aircraft and the like responding to the actuation. However, controls 130 can include, but is not limited to cockpit controls, a cockpit mock-up, tank controls, vehicle controls and the like. While only one set of controls 130 is depicted in FIG. 1 at viewing station 103-1, in other implementations, system 100 can comprise controls 130 for two or more viewing stations 103. Further, one or more viewing station 103 can be identifiable as being associated with a marked pairs of contact lenses 107 via a configuration of controls 130, as described above.

However, it is yet further appreciated that controls 130 are optional and content of images 106 can be pre-programmed and/or controlled by an administrator of system 100, and/or by computing device 115

In depicted implementations, system 100 further comprising receivers 150-1, 150-2 for receiving data associated with an immersive environment. Receivers 150-1, 150-2 will also be interchangeably referred to hereafter, collectively, as receivers 150 and generically as a receiver 150.

As depicted, receivers 150 can be in a one-to-one relationship with viewing stations 103; in other words, each viewing station 103 can comprise a receiver 150. However, in other implementations, system 100 can comprise fewer receivers than viewing stations 103; in other words each viewing station 103 need not comprise a receiver 150.

In depicted implementations, each of receivers 150 comprises headgear configured to be worn by viewers of viewing stations 150. For example, receivers 150 can include, but are not limited to, helmets, microphones, speakers, headsets, heads-up displays, and the like. As such, receivers 150 can receive data from computing device 115 associated with images 106, for example audio data for providing aural information associated with images 106 and/or visual data for providing visual information associated with images 106, for example on a heads-up display. In other words, receivers 150 are generally used in an immersive environment to simulate a physical real-world environment, such as a headgear that would be worn in a real-world cockpit. As such, use of special glasses for viewing images 106 respective to each viewing station 103 would physically interfere with receivers 150.

In some implementations, system 100 can further comprise viewing apparatus for use by a viewer (e.g. a gun mount, an optical measurement apparatus and the like) which, while not worn by a viewer, can be physically interfered with by glasses.

Use of contact lenses 107 mitigates such physical interference, such that a viewer of a viewing station 103 and/or a receiver 150 can use contact lenses 107 to view images 106 without having to worry about contact lenses 107 physically interfering with a receiver 150. However, as images 106 are provided respective to each viewing station 103, it is important to coordinate contact lenses 107 with viewers of each viewing station 103.

For example, attention is directed to FIG. 2, which depicts a subset of elements of system 100 with pairs of contact lenses 107 located at respective viewing stations 103. It is appreciated that while not all elements of system 100 are depicted in FIG. 2 for clarity (e.g. the links between controls 130, receivers 150 and computing device 115), they are nonetheless present.

It is further appreciated that, in FIG. 2. each respective pair of contact lenses 107 has been issued to a respective viewer of a viewing station 103 by matching a mark associated with each pair of contact lenses 107 with a respective viewing station 103, such that images 106 associated with a respective viewing station 103 are viewable from the respective viewing station 103 using a respective pair of contact lenses 107. For example, pair of contact lenses 107-1 has been issued to a viewer (not depicted) of viewing station 103-1 by matching the mark “1” at container 108-1 with the mark “1” of viewing station 103-1. Similarly, pair of contact lenses 107-2 has been issued to a viewer (not depicted) of viewing station 103-2 by matching the mark “2” at container 108-2 with the mark “2” of viewing station 103-2. However, as described above, an association between a given marked pair of contact lenses 107 and a given viewing station 103 is not limited to matching identical marks at each.

In any event, each of images 106 comprise one or more of a colour scheme and a polarization scheme respective to an associated viewing station 103, and respective pairs of contact lenses 107 are configured to separate and/or demultiplex at least one respective image 107 based on one or more of the colour scheme and the polarization scheme.

For example, in some implementations, each of the plurality of pairs of contact lenses 107 comprises a respective polarizer for separating at least one respective image 106 associated with a given respective viewing station 103, from images 106. Such polarizers can comprise one or more of linear polarizers, circular polarizers and the like. Hence, a subset of images 106 are configured to be demultiplexed d from images 106 with polarizers at pair of contact lenses 107-1, while a different subset of images 106 are configured to be demultiplexed from images 106 with polarizers at pair of contact lenses 107-2. For example, as depicted, pair of contact lenses 107-1 are configured to demultiplex images 106-1, 106-3 from images 106 and pair of contact lenses 107-2 are configured to demultiplex images 106-2, 106-n from images 106. In other words, a polarization state of each of images 106-1, 106-3 is similar to a polarization state of a polarizer at pair of contact lenses 107-1, while a polarization state of each of images 106-2, 106-n is different from a polarization state of a polarizer at pair of contact lenses 107-1. Hence, images 106-1, 106-3 are transmitted through pair of contact lenses 107-1 while images 106-2, 106-n are generally blocked from being transmitted through pair of contact lenses 107-1; similarly, images 106-2, 106-n are transmitted through pair of contact lenses 107-2 while images 106-1, 106-3 are generally blocked from being transmitted through pair of contact lenses 107-2. However, it is appreciated that blocking transmission can include attenuation of images 106 such a portion of a “blocked” image can still be partially transmitted.

It is further appreciated that images 106-1, 106-3 configured to be viewed from viewing station 103-1 and images 106-2, 106-n are configured to be viewed from viewing station 103-2. Hence, when a pair of contact lenses 107 associated with a respective viewing station 103 is issued to a viewer of a different viewing station 103, images 106 other than those intended to be viewed at the respective viewing station 103 will viewed; as pairs of contact lenses 107 cannot be easily exchanged between viewers, it is important in system 100 that each pair of contact lenses 107 be issued to a viewer of a corresponding viewing station 103, which is accomplished via marking of pairs of contact lenses 107.

It is further appreciated that images 106 could be reconfigured such that content initially in images 106 for viewing at viewing station 103-1 via contact lenses 107-1 can be changed to images 106 for viewing at viewing station 103-2 via contact lenses 107-2, for example if contact pairs of contact lenses 107 are incorrectly issued. However, such switching is again inconvenient and requires an administrator of system 100 to reconfigure images 106, which can further be time consuming and inefficient.

It is further appreciated that each subset of images 106 viewable via a given pair of contact lenses 107 generally provides full coverage of screen 101 such that a viewer at a given viewing station 103 is provided with a full immersive environment and/or field of view from the point of view of the given viewing station 103. A viewer at another given viewing station 103 is also provided with a full immersive environment and/or field of view from the point of view of the another given viewing station 103, via another subset of images 106 which are adjusted for the point of view of the another given viewing station 103. Hence, for example, a viewer at a “Co-Pilot” viewing station 103 will see the same scene as a viewer at a “Pilot” viewing station 103, but adjusted for the perspective of the “Co-Pilot” viewing station. This can be extremely important when objects in images 106 are depicted as close to each of viewing stations 103 as small changes in perspective can result in large changes in how the object is depicted and/or viewed.

However, present implementations are not so limiting and each subset of images 106 need not show the same scene. For example, each of the “Pilot” and “Co-Pilot” can be “looking” out of different windows in a simulated aircraft (e.g. one could be looking out the front of the aircraft and the other out the rear of the aircraft) and hence each subset of images 106 can show different scenes. Furthermore, each subset of images 106 can comprise completely different scenes such that system 100 effectively provides two different simulations simultaneously. In other words, subsets of images 106 can be related or unrelated as desired.

It is yet further appreciated that perspective in images 106 can be critical. For example, in some implementations, system 100 can comprises measurement tools for use by a viewer at a viewing station 103, for example to take “measurements” of a simulated scene in images 106; the measurement tools can require a view in images 106 to be provided at a given level of precision and/or a given resolution for an accurate measurement to be made. However, such perspective and/or accuracy is not to be understood as particularly limiting and can be customized for a given simulation.

It is further appreciated that while only two images 106 are depicted in each subset as being filtered for each pair of contact lenses 107, any number of images 106 can be filtered by each pair of contact lenses 107, and projected by any of projectors 105, to provide: a. about full coverage of screen 101 for a given viewer at a given viewing station 103; and b. a stream of images 106 to provide an immersive environment.

Alternatively, rather than polarizers, each of the plurality of pairs of contact lenses 107 can comprise a respective colour filter for separating the at least one respective image 106, associated with a given respective viewing station 103, from images 106. In other words, each of images 106 can comprise a respective colour scheme that is viewable through a respective pair of contact lenses 107 comprising a respective colour filter for filtering the respective colour scheme. Such colour filters can comprise one or more of optical notch filters, optical multi-notch filters, optical bandpass filters and the like. For example, each of images 106-1, 106-3 can comprise wavelengths and/or colours within given wavelength ranges transmittable by a colour filter at pair of contact lenses 107-1, but not transmittable by a colour filter at pair of contact lenses 107-2; similarly, each of images 106-2, 106-n can comprise wavelengths and/or colours within certain ranges transmittable by a colour filter at pair of contact lenses 107-2, but not transmittable by a colour filter at pair of contact lenses 107-1.

It is yet further appreciated that while pairs of contact lenses 107 are presently described as comprising passive polarizing filters and/or passive colour filters, in other implementations, filters at pairs of contact lenses 107 can be active filters. For example, filters at each pair of contact lenses 107 can comprise liquid crystal shutters which can be opened and closed for alternating viewing of images 106, the projection of images 106 for a given pair of contact lenses 107 coordinated with opening and closing the liquid crystal shutters.

However, it is yet further appreciated that other optical filters for demultiplexing images 106 is within the scope of present implementations.

Regardless of how images 106 are filtered by pairs of contact lenses 107, when a user (i.e. a viewer) of a viewing station 103 is to use system 100, the viewer first determines which given viewing station 103 they will be using, and then determines which pair of contact lenses 107 corresponds to the given viewing station 103 they will be using via marking of the pairs of contact lenses 107. The viewer then insert a pair of contact lenses 107 respective to the given viewing station 103, and then moves to the given viewing station 103 to begin viewing images 106 respective to the given viewing station 103; a receiver 150 respective to the given viewing station 103 can be worn, pairs of contact lenses 107 not physically interfering therewith. It is further appreciated that this procedure can be repeated for each viewer of each viewing station 103, the marking of pairs of contact lenses 107 ensuring that the appropriate contact lenses 107 are worn.

In depicted implementations, each of images 106 are monoscopic and each contact lens in a respective pair of contact lenses 107 is configured to demultiplex a same respective image 106 from images 106. In other words, each contact lens of a pair of contact lenses 107 is configured to transmit the same images, and images 106 are viewed monoscopically.

However, attention is next directed to FIG. 3 which depicts a system 100a, similar to system 100, with like elements having like numbers. However, system 100a comprises projectors 105a-1, 105a-2 configured to project optically-separable (and optionally aligned) stereoscopic images 106a-1, 106a-2, 106a-3 . . . 106a-n, which are separable via pairs of contact lenses 107a-1L, 107a-1R, and 107a-2L, 107a-2R.

Projectors 105a-1, 105a-2 will also be interchangeably referred to hereafter, collectively, as projectors 105a and generically as a projector 105a. Optically-separable images 106a-1, 106a-2, 106a-3 . . . 106a-n will also be interchangeably referred to hereafter, collectively, as images 106a and generically as an image 106a. Pairs of contact lenses 107a-1L, 107a-1R, and 107a-2L, 107a-2R will also be interchangeably referred to hereafter, collectively, as pairs of contact lenses 107a and generically as a pair of contact lenses 107a.

System 100a can further comprises a computing device 115a in communication with projectors 105a, controls 130 and receivers 150 (though links between computing device 115a, controls 130 and receivers 150 are not depicted for clarity), which in turn comprises a processor 120a, similar to processor 120, a memory 122a, similar to memory 122, and a communication interface 124a, similar to interface 124. Indeed, computing device 115a is generally similar to computing device 115, however computing device 115a is configured to provide stereoscopic image data to projectors 105a; similarly, projectors 105a are similar to projectors 105, however projectors 105a are configured to receive stereoscopic image data and project stereoscopic images 106a onto screen 101.

However, any suitable computing device, and/or any suitable number of computing devices, could be used to control system 100a (and/or system 100). For example each projector 105a can include a computing device and/or a separate computing device could be used to provide images for each contact lens in each pair of contact lenses 107a. Indeed, a number and type of computing devices is not to be considered particularly limiting.

Further, pairs of contact lenses 107a are initially stored in respective containers 108a-1L, 108a-1R, 108a-2L, 108a-2R, which will also be interchangeably referred to hereafter, collectively, as containers 108a and generically as a container 108a, similar to containers 108.

In any event, in these implementations, pairs of images 106a form stereoscopic images, but are otherwise similar to images 106. Further, a first contact lens 107a in a respective pair of contact lenses 107a is configured to demultiplex a left eye stereoscopic image 106a from images 106a, and a second contact lens in the respective pair of contact lenses 107a is configured to demultiplex a right eye stereoscopic image from images 106a. Each of the first contact lens and the second contact lens is further marked as for a left eye and right eye, respectively. Pairs of contact lenses 107a are otherwise similar to pairs of contact lenses 107.

For example, as depicted: of a pair of contact lenses 107a-1L, 107a-1R, first contact lens 107a-1L, initially stored in container 108a-1L, is configured to demultiplex a left eye stereoscopic image 106a-1 from images 106a; and, second contact lens 107a-1R, initially stored in container 108a-1R is configured to demultiplex a right eye stereoscopic image 106a-3 from images 106a. Similarly, of a pair of contact lenses 107a-2L, 107a-2R, first contact lens 107a-2L, initially stored in container 108a-2L, is configured to demultiplex a left eye stereoscopic image 106a-2 from images 106a; and, second contact lens 107a-2R, initially stored in container 108a-2R is configured to demultiplex a right eye stereoscopic image 106a-n from images 106a.

In other words, system 100a is similar to system 100, however pairs of stereoscopic images 106a respective to a point of view of each viewing station 103 are projected, rather than monoscopic images as in system 100; further contact lenses 107a are each configured to demultiplex images respective not only to an associated viewing station 103, but also for left eye of a viewer or a right eye of a viewer of the given viewing station 103. Hence, marking of each contact lens 107a is even more important than in system 100.

As such, each of first contact lenses 107a-1L, 107a-2L are marked as for a left eye via respective marks “1-L”, “2-L” at containers 108-1L, 108-2L, and each of second contact lenses 107a-1R, 107a-2R are marked as for a right eye via respective marks “1-R”, “2-R” at containers 108-1R, 108-2R. In other words “1” indicates that a contact lens 107a is to be used with a viewing station 103a that is similarly marked with “1”, “2” indicates that a contact lens is to be used with a viewing station 103a that is similarly marked with “2”, “L” indicates that a contact lens 107a is to be used with left eye, and “R” indicates that a contact lens 107a is to be used with a right eye. Such marking of contact lenses 107a enables not only the appropriate pair of contact lenses 107a to be used with a given viewing station 103, but also enables each contact lens 107a to be used with an appropriate eye at the given viewing station 103a.

Persons skilled in the art will appreciate that there are yet more alternative implementations and modifications possible. For example, while not depicted, in some implementations, either of system 100 (and/or system 100a) can further comprise contact lens stations in a one-to-one relationship with the plurality of pairs of contact lenses 107, each of the contact lens stations configured for one or more of issuing a respective pair of contact lenses 107 for a given respective viewing station 103 and inserting the respective pair of contact lenses 107 into eyes of a user of the given respective viewing station 107. For example, each respective contact lens station can comprise faucets, a sink and plumbing facilities therefore for washing hands and the like, and a mirror for assisting in inserting pairs of contact lenses 107 into an eye of user of the given viewing station 107.

Further, in these implementations, each of the plurality of pairs of contact lenses 107 are marked as associated with a respective viewing station 103 by a respective mark on a respective contact lens station, similar to marks “1” and “2” described above. Hence, when a user of a viewing station 103 is to use system 100, the viewer first determines which given viewing station 103 they will be using, and then determines which contact lens station corresponds to the given viewing station 103 they will be using via marks at the contact lens stations. It is appreciated that each contact lens station is provisioned with one or more pairs of contact lenses 107 respective to corresponding viewing stations 103. The viewer then uses the contact lens station to receive and insert a pair of contact lenses 107 respective to the given viewing station 103, and then moves to the given viewing station 103 to begin viewing images 106 respective to the given viewing station 103; a receiver 150 respective to the given viewing station 103 can be worn, pairs of contact lenses 107 not physically interfering therewith. It is further appreciated that this procedure can be repeated for each user of each viewing station 103, the marking of pairs of contact lenses 107 ensuring that the appropriate contact lenses 107 are worn.

While FIGS. 1 to 3 have been described with respect to viewing stations 103 and a projection display system, present implementations are not so limited. For example, attentions is next directed to FIG. 4 which depicts a system 100b similar to system 100, with like elements having like numbers with a “b” appended thereto. System 100b comprises: a display system 401 configured to display multiplexed images 106b comprising at least a first set of images 106b-1, 106b-3 and a second set of images 106b-2, 106b-n optically-separable from the first set; a first pair of contact lenses 107b-1 marked as associated with the first set of images 106b-1, 106b-3 and configured to demultiplex the first set from the second set; and, a second pair of contact lenses 107b-2 marked as associated with the second set of images 106b-2, 106b-n and configured to demultiplex the second set from the first set. It is appreciated that images 106b-1, 106b-2, 106b-3, 106b-n are interchangeably referred to collectively as images 106b and generically as an image 106b. First pair of contact lenses 107b-1 and second pair of contact lenses 107b-2 are hereafter interchangeably referred to collectively as pairs of contact lenses 107b (and/or contact lenses 107b) and generically as a pair of contact lenses 107b.

Similar to contact lenses 107 described above, the first set of images 106b-1, 106b-3 and the second set of images 106b-2, 106b-n are optically separable and/or multiplexed via one or more of different respective colour schemes and different respective polarization schemes. Further each of the first pair of contact lenses 107b-1 and the second pair of contact lenses 107b-2 comprise one or more of different respective colour schemes and different respective polarization schemes for respectively demultiplexing the first set of images 106b-1, 106b-3 from the second set of images 106b-2, 106b-n, and the second set of images 106b-2, 106b-n from the first set of images 106b-1, 106b-3.

Each of first pair of contact lenses 107b-1 and second pair of contact lenses 107b-2 can be marked as associated with a respective set of images using one or more of text, graphics, RFID (radio frequency identification) tags and NFC (near field communication) tags, as described above. As depicted, system 100 further comprises a first container 108b-1 for the first pair of contact lenses 107b-1 and a second container 108b-2 for the second pair of contact lenses 107b-2, and each of first pair of contact lenses 107b-1 and second pair of contact lenses 107b-2 are marked as associated with respective images 106b using respective marking on each of first container 108b-1 and second container 108b-2. Specifically, container 108b-1 is marked with a “1” indicating first pair of contact lenses 107b-1 contained therein is associated with first set of images 106b-1, and container 108b-2 is marked with a “2” indicating second pair of contact lenses 107b-2 contained therein is associated with second set of images 106b-2.

Each of first container 108b-1 and second container 108b-2 can comprise one or more of a contact lens case, an envelope, contact lens packaging, a box, and a holder, similar to containers 108.

In contrast to systems 100, 100a, system 1001) need not comprise projector display system (including a screen), though display system 401 could comprise a projector display system. Indeed, display system 401 can comprise one or more of a projector display system, a flat panel display system, a tiled display system, a cathode ray display system, an LCD (liquid crystal display) system, an OLED (organic light emitting diode) display system, and the like. When display system 401 comprises a projector display system, display system 401 comprises a projector and a screen upon which the projector projects first set of images 106b-1, 106b-3 and second set of images 106b-2, 106b-n, similar to system 100.

However, as depicted, display system 401 comprises a flat panel display system.

Regardless, display system 401 is configured to generate the multiplexed images 106b one or more of concurrently and alternately, as in system 100.

Also similar to system 100, system 100b further comprises a computing device 115b configured to generate multiplexed images 106b for display by display system 401. Indeed, computing device 115b is in communication with display system 401 and comprises a processor 120b, a memory 122b, and a communication interfaces 124b, each respectively similar to processor 120, memory 122 and interface 124. It is yet further appreciated that, in some implementations; computing device 115b can be incorporated into display system 401.

Regardless of a configuration of display system 401, it is appreciated that system 100b comprises an immersive environment and/or a simulation environment such that viewers using contact lenses 107b-1, 107b-2 to view images 106b at display system 401, are appreciated to be participating in a simulation, for example a cockpit simulation and the like.

However, in further contrast to system 100, system 100b does not necessarily comprise viewing stations. Rather, system 1001) can comprise a first viewing position 403-1 for viewing display system 401 using first pair of contact lenses 107b-1 and a second viewing position 403-2 for viewing display system 401 using second pair of contact lenses 107b-2, wherein each of first pair of contact lenses 107b-1 and second pair of contact lenses 107b-2 are marked as associated with respective images using marks associated with respective viewing positions 403-1, 403-2 (viewing positions 403-1, 403-2 interchangeably referred to hereafter collectively as viewing positions 403 and generically as a viewing position 403). For example the mark “1” at container 108b-1 can correspond to viewing position 403-1 and the mark “2” at container 108b-2 can correspond to viewing position 403-2.

It is appreciated that viewing positions 403 need not be a specific area in front of display system 401, but simply comprise a starting position for a viewer wearing corresponding pairs of contact lenses 107b. Indeed, in some implementations, system 100b can further comprise apparatus (not depicted) for tracking one or more of a position of a viewer and headtracking of a viewer relative to display system 401, though, in general, system 100b is configured to determine a first position of each of viewers wearing contact lenses 107b. Hence, each of first viewing position 403-1 and second viewing position 403-2 can be mobile, in that once a first position of each of viewers is determined, the viewer can move relative to display system 401; images 106b can be adjusted accordingly to correct for perspective of a viewer as a viewing position 403 and/or a viewer changes. However, it is appreciated that first viewing position 403-1 and second viewing position 403-2 need not be fixed positions; indeed, in some implementations, such viewer tracking does not require viewers to be in any type of starting position. Rather, tracking can be active and/or marked. As such, tracking apparatus can determine which position is being tracked based on, for example, an identifier in tracking signals.

Alternatively, system 100b can be similar to system 100 and each of first viewing position 403-1 and second viewing position 403-2 can comprise one or more of a viewing station, seat, controls for controlling the multiplexed images in an immersive environment and receivers for receiving immersive environment data, as described above.

In yet further implementations, system 100b can further comprise a first contact lens station and a second contact lens station, as described above, each configured for one or more of issuing a respective pair of contact lenses 107b and inserting a respective pair of contact lenses 107b into eyes of a viewer, wherein each of the first contact lens station and the second contact lens station are marked as associated with respective images 106b using marks associated with contact lens stations. In other words, marks “1” and “2” can be provided at the contact lens stations rather than on a container 108b.

As described above with respect to images 106a, each of the first set of images 106b-1, 106b-3 and second set of images 106b-2, 106b-n can comprise respective stereoscopic images, and each of first set of contact lenses 106b-1 and second set of contact lenses 106b-2 can be configured to demultiplex the respective stereoscopic images. Hence, in these implementations, each contact lens 107b in the first set of contact lenses 107b-1 and the second set of contact lenses 107b-2 can be further marked as associated with one of a right eye and a left eye.

Alternatively, images 106b can be similar to images 106 and hence each of the first set of images 106b-1, 106b-3 and second set of images 106b-2, 106b-n can comprise respective monoscopic images. In these implementations, each of first set of contact lenses 107b-1 and second set of contact lenses 107b-2 are configured to demultiplex the respective monoscopic images 106b.

Also similar to images 106 described above, in some implementations, each of first set of images 106b-1, 106b-3 and second set of images 106b-2, 106b-n can comprise a similar scene. In some of these implementations, the similar scene can be rendered at different perspectives accounting for the different angles in which viewers are viewing display system 401 from different viewing positions 403. However, in other implementations, first set of images 106b-1, 106b-3 and second set of images 106b-2, 106b-n can comprise a different scene, such that system 100 can provide two different simulations which can be related (e.g. front and rear views from an airplane) or unrelated.

Hence, in general, by providing contact lenses, rather than glasses, for viewing and filtering images in an immersive environment, a more realistic viewing experience can be provided, without interference by the viewing apparatus, i.e. the contact lenses. For example, contact lenses do not interfere with other headgear worn by a user of the immersive environment. Further, contact lenses provide a better viewing field than glasses, which tend to limit the peripheral vision of the user. However, glasses can be more easily exchanged between users, as compared to contact lenses, should the wrong glasses be issued to a user. However, marking of the contact lenses, as described herein obviates this issue as the marking assists with issuing the appropriate pair of contact lenses to a user of a given viewing station

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A system comprising:
a display system configured to display multiplexed images comprising at least a first set of images and a second set of images optically-separable from the first set;
a first pair of contact lenses marked as associated with the first set of images an configured to demultiplex the first set from the second set; and,
a second pair of contact lenses marked as associated with the second set of images and configured to demultiplex the second set from the first set.

2. The system of claim 1, wherein the first set and the second set are optically separable via one or more of different respective colour schemes and different respective polarization schemes.

3. The system of claim 1, wherein each of the first pair of contact lenses and the second pair of contact lenses comprise one or more of different respective colour schemes and different respective polarization schemes for respectively demultiplexing the first set from the second set and the second set from the first set.

4. The system of claim 1, wherein each of the first pair of contact lenses and the second pair of contact lenses are marked as associated with a respective set of images using one or more of text, graphics, RFID (radio frequency identification) tags and NFC (near field communication) tags.

5. The system of claim 1, further comprising a first container for the first pair of contact lenses and a second container for the second pair of contact lenses, wherein each of the first pair of contact lenses and the second pair of contact lenses are marked as associated with respective images using respective marking on each of the first container and the second container.

6. The system of claim 5, wherein each of the first container and the second container comprise one or more of a contact lens case, an envelope, contact lens packaging, a box, and a holder.

7. The system of claim 1, further comprising a first viewing position for viewing the display system using the first pair of contact lenses and a second viewing position for viewing the display system using the second pair of contact lenses, wherein each of the first pair of contact lenses and the second pair of contact lenses are marked as associated with respective images using marks associated with respective viewing positions.

8. The system of claim 7, wherein each of the first viewing position and the second viewing position is mobile.

9. The system of claim 7, wherein each of the first viewing position and the second viewing position comprise one or more of a viewing station seat, controls for controlling the multiplexed images in an immersive environment and receivers for receiving immersive environment data.

10. The system of claim 1, further comprising a first contact lens station and a second contact lens station, each configured for one or more of issuing a respective pair of contact lenses and inserting the respective pair of contact lenses into eyes of a viewer, wherein each of the first contact lens station and the second contact lens station are marked as associated with respective images using marks associated with respective contact lens stations.

11. The system of claim 1, wherein each of the first set of images and the second set of images comprise respective stereoscopic images, and each of the first set of contact lenses and the second set of contact lenses are configured to demultiplex the respective stereoscopic images.

12. The system of claim 11 wherein each contact lens in the first set of contact lenses and the second set of contact lenses are further marked as associated with one of a right eye and a left eye.

13. The system of claim 1, wherein each of the first set of images and the second set of images comprise respective monoscopic images, and each of the first set of contact lenses and the second set of contact lenses are configured to demultiplex the respective monoscopic images.

14. The system of claim 1, wherein each of the first set of mages and the second set of images comprise a similar scene.

15. The system of claim 1, wherein each of the first set of images and the second set of images comprise a different scene.

16. The system of claim 1, wherein the display system comprises one or more of a projector display system, a flat panel display system, a tiled display system, a cathode ray display system, an LCD (liquid crystal display) system, and a OLED (organic light emitting diode) display system.

17. The system of claim 1, wherein the display system comprises a projector and a screen upon which the projector projects the first set and the second set.

18. The system of claim 1, wherein the display system is configured to generate the multiplexed images one or more of concurrently and alternately.

19. The system of claim 1, further comprising a computing device configured to generate the multiplexed images for display by the display system.

20. The system of claim 1, further comprising an immersive environment.
